(19) United States
(12) Patent Application Publication
(10) Pub. No.: US 2005/0096059 A1
(43) Pub. Date: May 5, 2005

(54) Method of indicating delay

(76) Inventors: Frances Jiang, Whippany, NJ (US); Gopal N. Kumar, Morristown, NJ (US); Aparajita Misra, Basking Ridge, NJ (US); Ganapathy Subramanian Sundaram, Hillsborough, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/699,452

(22) Filed: Oct. 31, 2003

(51) Int. Cl. H04Q 7/20

(52) U.S. Cl. 455/450; 455/453; 455/455

(57) ABSTRACT

A method of wireless communication. The method includes the step of transmitting at least one message including delay information. This delay information may correspond with a delay length associated with accessing a service through an open loop network. The delay length may include a time interval between a first instant corresponding with a received service request and a second instant corresponding with granting service access. Alternatively, the delay length may comprise a time interval between a first instant corresponding with a received service request generating at a predefined moment in time and a second instant corresponding with granting service access. The delay length may correspond with traffic congestion, channel condition, system loading, processor occupancy, queuing delay, and/or scheduling delay, for example. The method may also include the step of collecting information corresponding with traffic, channel condition and/or service demand(s) to determine a pattern(s) over time using, for example, a heuristic technique.

### BACKGROUND OF THE INVENTION

I. Field of the Invention

The present invention relates to telecommunications, and more particularly, to wireless and wireline communications.

II. Description of the Related Art

Wireless communications systems provide wireless service to a number of wireless or mobile units situated within a geographic region. The geographic region supported by a wireless communications system is divided into spatially distinct areas commonly referred to as “cells.” Each cell, ideally, may be represented by a hexagon in a honeycomb pattern. In practice, however, each cell may have an irregular shape, depending on various factors including the topography of the terrain surrounding the cell. Moreover, each cell is further broken into two or more sectors. Each cell is commonly divided into three sectors, each having a range of 120 degrees, for example.

A conventional cellular system comprises a number of cell sites or base stations geographically distributed to support the transmission and reception of communication signals to and from the wireless or mobile units. Each cell site handles voice communications within a cell. Moreover, the overall coverage area for the cellular system may be defined by the union of cells for all of the cell sites, where the coverage areas for nearby cell sites overlap to ensure, where possible, contiguous communication coverage within the outer boundaries of the system's coverage area.

Each base station comprises at least one radio and at least one antenna for communicating with the wireless units in that cell. Moreover, each base station also comprises transmission equipment for communicating with a Mobile Switching Center (“MSC”). A mobile switching center is responsible for, among other things, establishing and maintaining calls between the wireless units, between a wireless unit and a wireline unit through a public switched telephone network (“PSTN”), as well as between a wireless unit and a packet data network (“PDN”), such as the Internet. A base station controller (“BSC”) administers the radio resources for one or more base stations and relays this information to the MSC.

When active, a wireless unit receives signals from at least one base station over a forward link or downlink and transmits signals to at least one base station over a reverse link or uplink. Several approaches have been developed for defining links or channels in a cellular communication system, including time-division multiple access (“TDMA”), code-division multiple access (“CDMA”) and orthogonal-frequency division multiple access (“OFDMA”), for example.

In TDMA communication systems, the radio spectrum is divided into time slots. Each time slow allows only one user to transmit and/or receive. Thusly, TDMA requires precise timing between the transmitter and receiver so that each user may transmit their information during their allocated time.

In a CDMA scheme, each wireless channel is distinguished by a distinct channelization code (e.g., spreading code, spread spectrum code or Walsh code). Each distinct channelization code is used to encode different information streams. These information streams may then be modulated at one or more different carrier frequencies for simultaneous transmission. A receiver may recover a particular stream from a received signal using the appropriate channelization code to decode the received signal.

In OFDMA systems, a carrier signal may be defined by a number (e.g., 1024) of sub-carriers or tones transmitted using a set of mathematically time orthogonal continuous waveforms Each wireless channel may be distinguished by a distinct channelization tone. By employing orthogonal continuous waveforms, the transmission and/or reception of the tones may be achieved, as their orthogonality prevents them from interfering with one another.

For voice applications, conventional cellular communication systems employ dedicated links between a wireless unit and a base station. Voice communications are delay-intolerant by nature. Consequently, wireless units in wireless cellular communication systems transmit and receive signals over one or more dedicated links. Here, each active wireless unit generally requires the assignment of a dedicated link on the downlink, as well as a dedicated link on the uplink.

While voice applications may be the present mainstay of cellular communication, service providers have begun exploring new growth opportunities. One such prospect has centered on the explosion of the Internet and the increasing demand for data. Next generation wireless communication systems are expected to provide data services, such as High Speed Downlink Packet Access (“HSDPA”) and High Speed Uplink Packet Access (“HSUPA”), in support of Internet access, gaming and multimedia communication. Unlike voice, these forms of data communications are relatively delay tolerant and may be bursty in nature. Data communication, as such, may not require dedicated links on the downlink or the uplink, but rather may employ one or more channels shared by a number of wireless units. By this arrangement, each of the wireless units on the uplink may compete for available resources.

While data communications may be relatively delay tolerant and potentially bursty in nature, traffic growth may pose a threat to the promise offered by data services. As the numbers of subscribers to data services begin proliferate, potential access delays may mount. Without recognizing the length of access delays, the appeal of these data services may decrease as the frustration of each subscriber increases.

Consequently, a demand exists for a method of indicating a delay to a subscriber seeking to gain network access. A need also exists for a method of calculating the length a delay to a subscriber in accessing a service, for example, from a service providers' network.

### SUMMARY OF THE INVENTION

The present invention provides a method of indicating a delay to a subscriber seeking to gain network access. More particularly, the method of the present invention provides a technique for calculating the length of a delay that an access user or subscriber, for example, may experience in accessing a service. This service may be provided from, for example, an open loop wireless network and/or wireline network. For the purposes of the present disclosure, the delay may correspond with a time interval between a first instant that a subscriber initiates a service request to a provider's network—or, in the alternative, the instant when a service request is autonomously initiated at a predefined (e.g., periodic or aperiodic) moment in time—and a second instant in which service access is granted to the subscriber. Consequently, the delay may be derived by a heuristic method based on information, such as traffic congestion patterns, channel condition patterns, and/or service demand patterns, for example, collected over time.

In an exemplary embodiment, a method of the present invention includes the step of transmitting at least one message comprising delay information. This delay information may correspond with a delay length associated with accessing a service through an open loop network. The delay length may comprise a time interval between a first instant corresponding with a received service request and a second instant corresponding with granting service access. Alternatively, the delay length may comprise a time interval between a first instant corresponding with a received service request generating at a predefined moment in time and a second instant corresponding with granting service access. The delay length may correspond with traffic congestion, channel condition, system loading, processor occupancy, queuing delay, and/or scheduling delay, for example. The method may also include the step of collecting information corresponding with traffic, channel condition and/or service demand(s) to determine a pattern(s) over time. These patterns may be developed using a heuristic technique(s).

In another exemplary embodiment, a method of the present invention includes the step of receiving at least one message comprising delay information. This delay information may correspond with a delay length associated with accessing a service through an open loop network. The delay length may comprise a time interval between a first instant corresponding with generating a service request and a second instant corresponding with receiving a service access grant. Alternatively, the delay length may comprise a time interval between a first instant corresponding with an autonomous service request generated at a predefined moment in time and a second instant corresponding with granting service access. The delay length may correspond with traffic congestion, channel condition, system loading, processor occupancy, queuing delay, and/or scheduling delay, for example. The method may also include the step of generating information corresponding with traffic, channel condition and/or service demand(s). This information may be used by the generator of the message to determine a pattern(s) over time and thereby calculate the delay information using a heuristic technique(s).

These and other embodiments will become apparent to those skilled in the art from the following detailed description read in conjunction with the appended claims and the drawings attached hereto.

### BRIEF DESCRIPTION OF THE DRAWINGS

The present invention will be better understood from reading the following description of non-limiting embodiments, with reference to the attached drawings, wherein below:

FIG. 1 depicts a flow chart according to an embodiment of the present invention; and

FIG. 2 depicts a flow chart according to another embodiment of the present invention; and

FIG. 3 depicts a flow chart according to another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

Referring to FIG. 1, an exemplary flow chart 10 of an embodiment of the present invention is illustrated. More particularly, flow chart 10 depicts a method of communicating a delay message to a subscriber seeking to gain network access to a service. This service may be provided via an open loop wireless network and/or open loop wireline network from, for example. The method depicted may include calculating the length of a delay that an access user or subscriber might experience, as detailed hereinbelow.

The method corresponding with flow chart 10 initially collects information related to communications delay (step 20). This communications delay information may correspond with the open loop nature of the network into which a subscriber and/or user is seeking to gain access. Consequently, the delay information collected may be associated with conditions experienced by the network. In one example, this step includes the collection of one or more parameters associated with service access of a network. Here, the parameter(s) may include traffic congestion, channel condition, system loading, processor occupancy, queuing delay and/or scheduling delay.

Once the delay information has been collected, the method includes the step of determining a pattern from the collected information (step 30). As the delay information is collected over time, various patterns associated with delays and system timing may emerge. For example, delay information associated with traffic congestion collected over time may establish a peak(s) and a lull(s) in network usage during certain time intervals. The determination of patterns associate with the formation of a delay length may therefore be based on a heuristic technique.

The method also includes the step of receiving a service request (step 40). This service request may be received at any time—e.g., while delay information is being collected and/or when patterns are being determined. It should be noted that the service request might be initiated directly by a subscriber and/or user. In the alternative, however, this service request may be autonomously initiated at a predefined moment in time by the subscriber/user's equipment. This autonomous initiation may be periodic or aperiodic in nature.

Once a service request is received, the method examines the information collected, as well as any patterns that may be heuristically determined over time. In response, the method then may transmit a delay-indicating message to the subscriber and/or user seeking to gain access (step 50). In one example, this delay-indicating message may be transmitted over a forward access channel (e.g., FACH) and/or a broadcast channel (e.g., BCCH).

It should be noted that the delay-indicating message might correspond with the computed delay length that may be calculated as a result of determining a pattern from the collected information (step 30). Moreover, the delay length may also correspond with a time interval between a first instant that the subscriber and/or user initiates a service request to a provider's network and a second instant in which service access is granted to the subscriber. Alternatively, delay length may correspond with a time interval between a first instant when a service request is autonomously initiated at a predefined (e.g., periodic or aperiodic) moment in time and a second instant in which service access is granted to the subscriber.

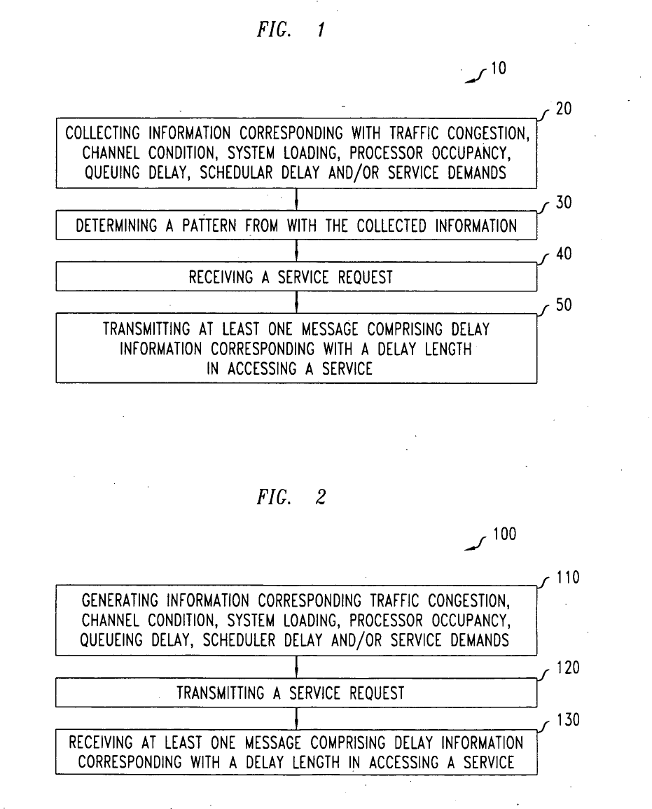

Referring to FIG. 2, an exemplary flow chart 100 of another embodiment of the present invention is illustrated. More particularly, flow chart 100 depicts a method of communicated a delay message. The delay message is intended to be received by a subscriber seeking to gain network access to a service provided via an open loop network (e.g., wireless and/or wireline).

The method corresponding with flow chart 100 initially involves generating information (step 110). The information being generated may include one or more parameters, such as traffic congestion, channel condition, system loading, processor occupancy, queuing delay and/or scheduling delay. By this step, the network accumulates information from various sources to calculate the length of a delay that an access user or subscriber might experience. This communications delay information may correspond with the open loop nature of the network into which a subscriber and/or user is seeking to gain access. The generation of information may include the participation of the user/subscriber.

After information is generated associated with traffic congestion, channel condition, system loading, processor occupancy, queuing delay and/or scheduling delay, a service request is transmitted by a subscriber and/or user (step 120). This service request may be transmitted at any time and may be initiated directly by a subscriber/user. In the alternative, however, this service request may be autonomously initiated at a predefined moment in time by the subscriber/user's equipment. This autonomous initiation may be periodic or aperiodic in nature.

Once a service request is transmitted, the method calculates what delay might be expected by examining the generated information, as well as any patterns that may be heuristically determined over time. In response, a delay-indicating message may then be received by the subscriber/user seeking to gain access (step 130). This delay-indicating message corresponds with the computed delay length that may be calculated as a result of determining a pattern from the collected information. The delay length may correspond with a time interval between a first instant that the subscriber and/or user initiates a service request to a provider's network and a second instant in which service access is granted to the subscriber. Alternatively, delay length may correspond with a time interval between a first instant when a service request is autonomously initiated at a predefined (e.g., periodic or aperiodic) moment in time and a second instant in which service access is granted to the subscriber.

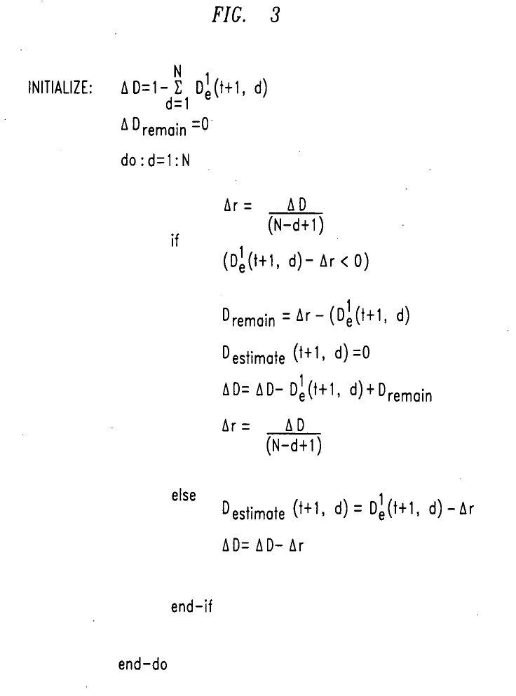

Referring to FIG. 3, an exemplary flow chart 200 of yet another embodiment of the present invention is illustrated. More particularly, flow a method of calculating a delay. This delay is the value to be expected by a subscriber seeking to gain network access to a service provided via an open loop network. Principally, this expected delay might be modeled using a delay distribution algorithm. The delay distribution may be derived from data collected over time (e.g., continuous or a defined learning period).

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center, for example. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A method of communication comprising:
transmitting at least one message comprising delay information corresponding with a delay length associated with accessing a service though an open loop network.

2. The method of claim 1, wherein the delay length comprises at least one time interval between a first instant corresponding with a received service request and a second instant corresponding with granting service access.

3. The method of claim 1, wherein the delay length comprises at least one time interval between a first instant corresponding with a received autonomous service request generated at a predefined moment in time and a second instant corresponding with granting service access.

4. The method of claim 3, wherein the predefined moment in time comprises at least one of a periodic and an aperiodic instant.

5. The method of claim 1, wherein the delay length corresponds with at least one of traffic congestion, channel condition, system loading, processor occupancy, queuing delay, and scheduler delay.

6. The method of claim 1, wherein the open loop network comprises at least one of a wireline network and a wireless network.

7. The method of claim 6, comprising:
collecting information corresponding with at least one parameter associated with service access.

8. The method of claim 7, comprising:
determining at least one pattern associated with the at least one parameter.

9. The method of claim 8, wherein the at least one parameter comprises at least one of traffic, channel condition, and service demand.

10. A method of communication comprising:
receiving at least one message comprising delay information corresponding with a delay length associated with accessing a service through an open loop network.

11. The method of claim 10, wherein the delay length comprises at least one time interval between a first instant corresponding with generating a service request and a second instant corresponding with receiving a service access grant.

12. The method of claim 10, wherein the delay length comprises at least one time interval between a first instant corresponding with an autonomous service request generated at a predefined moment in time and a second instant corresponding with granting service access.

13. The method of claim 12, wherein the predefined moment in time comprises at least one of a periodic and an aperiodic instant.

14. The method of claim 10, wherein the delay length corresponds with at least one of traffic congestion, channel condition, system loading, processor occupancy, queuing delay, and scheduler delay.

15. The method of claim 10, wherein the open loop network comprises at least one of a wireline network and a wireless network.

16. The method of claim 15, comprising:
generating information corresponding with at least one parameter associated with service access.

17. The method of claim 16, wherein the at least one parameter comprises at least one of traffic, channel condition and service demand.
